(19) United States
(12) Patent Application Publication
(10) Pub. No.: US 2026/0336356 A1
(43) Pub. Date: Oct. 29, 2026

(54) DEVICE FOR THERMAL MANAGEMENT OF AN ELECTRIC OR HYBRID MOTOR VEHICLE, COMPRISING A REFRIGERANT CIRCUIT

(71) Applicant: VALEO SYSTEMES THERMIQUES, Le Mesnil-Saint-Denis (FR)

(72) Inventors: Mohamed Yahia, Le Mesnil-Saint-Denis (FR); Stefan Karl, Le Mesnil-Saint-Denis (FR)

(73) Assignee: VALEO SYSTEMES THERMIQUES, Le Mesnil-Saint-Denis (FR)

(21) Appl. No.: 19/120,546

(22) PCT Filed: Oct. 12, 2023
(86) PCT No.: PCT/EP2023/078283

§ 371 Date: Apr. 11, 2025

(30) Foreign Application Priority Data
Oct. 12, 2022 (FR) FR2210501

(51) Int. Cl. B60H 1/00; B60H 1/32

(52) U.S. Cl. CPC B60H 1/00385; B60H 1/3227; B60H 1/32284; B60H 1/3229

(57) ABSTRACT

A device for thermal management of an electric or hybrid motor vehicle, the thermal management device includes a refrigerant circuit inside which a refrigerant circulate. The refrigerant circuit includes, in the direction of circulation of the refrigerant: a compressor, a condenser for absorbing heat energy from the refrigerant, a pre-expansion device arranged directly upstream of a tank bottle, a main expansion device, and an evaporator for transmitting heat energy to the refrigerant.

The invention relates to the field of electric or hybrid motor vehicles and more particularly to a device for thermal management within such a vehicle.

Present-day electric or hybrid motor vehicles are increasingly often comprising a heat transfer fluid circuit for the thermal management of the batteries. Specifically, in order for these batteries to be as efficient as possible they need to remain at an optimum operating temperature. It is therefore necessary to cool them during use to ensure that they do not exceed this optimum operating temperature by too great an extent. Likewise, it may also be necessary to heat these batteries, for example in cold weather, so that they reach this optimum operating temperature in the shortest possible time.

It is also known that electric or hybrid motor vehicles comprise a refrigerant circuit which contributes to the thermal management of the batteries, of the passenger compartment and of other components of the vehicle. When the weather is particularly hot, it can be necessary to greatly cool down the temperature of the batteries so that they stay at their optimum operating temperature. In these conditions, the refrigerant must be able to store as much heat energy from the batteries as possible. However, it is difficult to achieve this aim with present-day thermal management devices.

One of the objects of the present invention is therefore to at least partially overcome the disadvantages of the prior art and to propose an improved thermal management device.

The invention therefore relates to a thermal management device for an electric or hybrid motor vehicle, said thermal management device comprising a refrigerant circuit inside which a refrigerant is intended to circulate, the refrigerant circuit comprising the following, in the direction of circulation of the refrigerant:
a compressor,
a condenser for absorbing heat energy from the refrigerant,
a pre-expansion device disposed directly upstream of a storage cylinder,
a main expansion device, and
an evaporator for transmitting heat energy to the refrigerant.

Arranging a pre-expansion device directly upstream of the storage cylinder allows the thermal management device according to the invention to advantageously obtain a greater reduction in the temperature upstream of the storage cylinder and therefore a greater difference in enthalpy, making it possible to absorb more heat energy at the evaporator.

In the invention, “directly upstream” is understood to mean that no other device that has an impact on the pressure and/or the temperature of the refrigerant is disposed on the path taken by the refrigerant between the two elements in question, which in the present case are the pre-expansion device and the storage cylinder.

According to one embodiment of the invention, the condenser comprises an additional heat exchanger through which both the refrigerant and an auxiliary fluid are intended to flow, the pre-expansion device comprising a first pre-expansion device, and wherein the thermal management device comprises, in the direction of circulation of the refrigerant, a main loop comprising, in the direction of the refrigerant, the compressor, the additional heat exchanger, the first pre-expansion device disposed directly upstream of the storage cylinder, the main expansion device, and the evaporator.

According to one aspect of the invention, the main loop is a first main loop, wherein the condenser further comprises a first condenser which is intended to heat an auxiliary fluid and is disposed on the first main loop in the direction of circulation of the refrigerant between the compressor and the additional heat exchanger.

In particular, the pre-expansion device comprises a second pre-expansion device, the thermal management device comprises a first bypass pipe joining a first connection point, disposed on the first main loop downstream of the first condenser, to a second connection point, disposed on the first main loop between the first pre-expansion device and the storage cylinder, and the second pre-expansion device is disposed between the first condenser and the storage cylinder.

According to another aspect of the invention, the thermal management device further comprises:
a fourth bypass pipe joining a seventh connection point, disposed on the first main loop downstream of the storage cylinder, to an eighth connection point, disposed on the first main loop between the first pre-expansion device and the storage cylinder, and
a fifth bypass pipe joining a ninth connection point, disposed on the first main loop downstream of the additional heat exchanger, to a tenth connection point, disposed on the first main loop downstream of the evaporator.

Notably, the thermal management device according to the invention further comprises a sixth bypass pipe joining an eleventh connection point, disposed on the first main loop downstream of the compressor, to a twelfth connection point, disposed on the first main loop upstream of the additional heat exchanger.

Notably, the thermal management device further comprises a third bypass pipe joining a fifth connection point, disposed on the first main loop downstream of the first condenser, to a sixth connection point, disposed on the first main loop between the additional heat exchanger and the first pre-expansion device.

According to another aspect of the invention, the main loop is a second main loop, the condenser further comprises a first condenser for transmitting heat energy to an internal air flow, and the thermal management device comprises, in the direction of circulation of the refrigerant, a first bypass branch connecting a first junction point, disposed on the second main loop downstream of the compressor, to a second junction point, disposed on the second main loop upstream of the first pre-expansion device, said first bypass branch comprising the first condenser.

In particular, the thermal management device of the invention further comprises a second bypass branch connecting a third junction point, disposed on the second main loop downstream of the first condenser, to a fourth junction point, disposed on the second main loop upstream of the additional heat exchanger, said second bypass pipe comprising a secondary expansion device.

Further features and advantages of the present invention will become more clearly apparent from reading the following description, which is given by way of non-limiting illustration, and with reference to the accompanying drawings, in which:

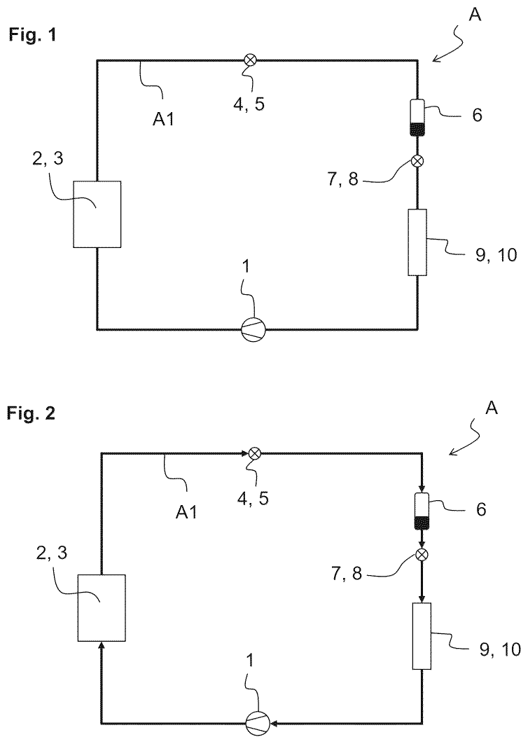

FIG. 1 is a schematic depiction of a thermal management device according to a first general embodiment.

FIG. 2 is a schematic depiction of the thermal management device in FIG. 1 according to a general mode of operation.

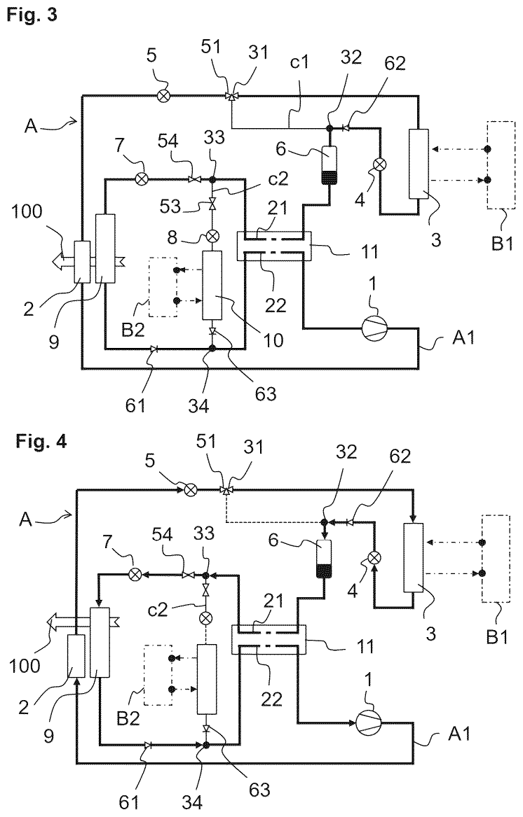

FIG. 3 is a schematic depiction of a thermal management device according to a second embodiment.

FIG. 4 is a schematic depiction of the thermal management device in FIG. 3 according to a first mode and a second mode of operation.

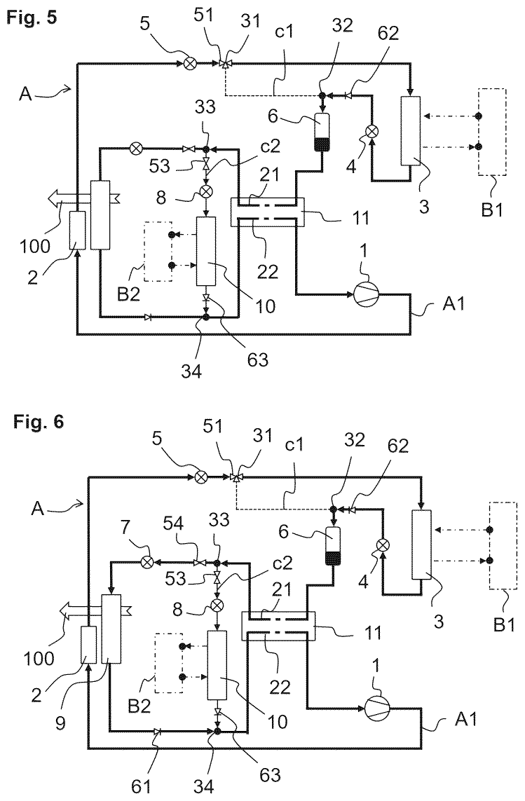

FIG. 5 is a schematic depiction of the thermal management device in FIG. 3 according to a third mode of operation.

FIG. 6 is a schematic depiction of the thermal management device in FIG. 3 according to a fourth mode of operation.

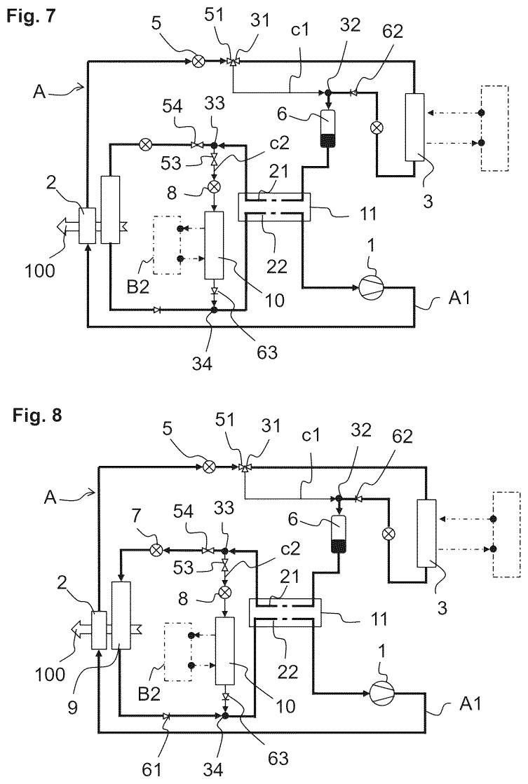

FIG. 7 is a schematic depiction of the thermal management device in FIG. 3 according to a fifth mode of operation.

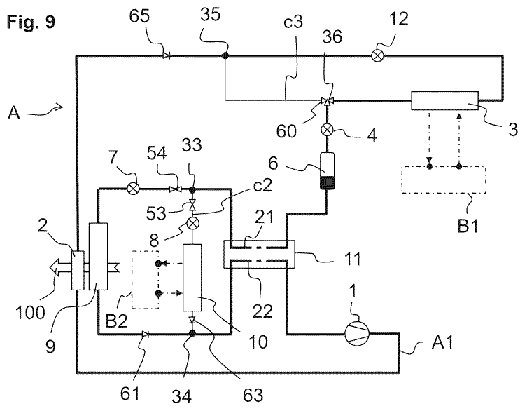

FIG. 8 is a schematic depiction of the thermal management device in FIG. 3 according to a sixth mode of operation.

FIG. 9 is a schematic depiction of a thermal management device according to a third embodiment.

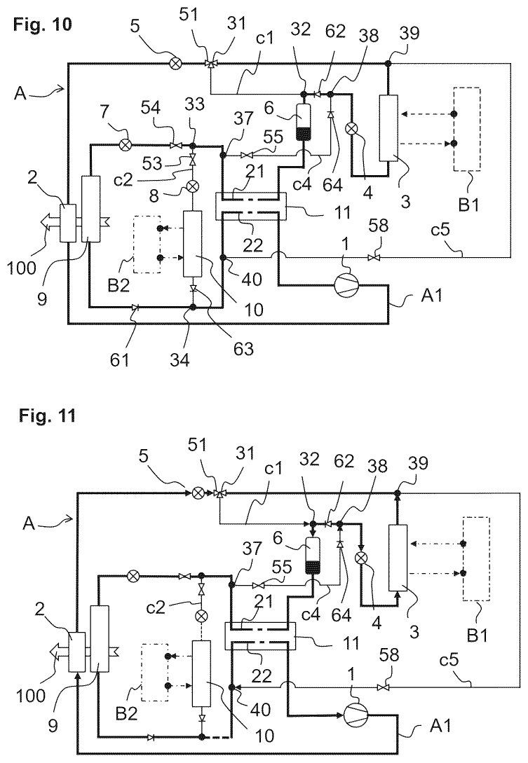

FIG. 10 is a schematic depiction of a thermal management device according to a fourth embodiment.

FIG. 11 is a schematic depiction of the thermal management device in FIG. 10 according to a seventh mode of operation.

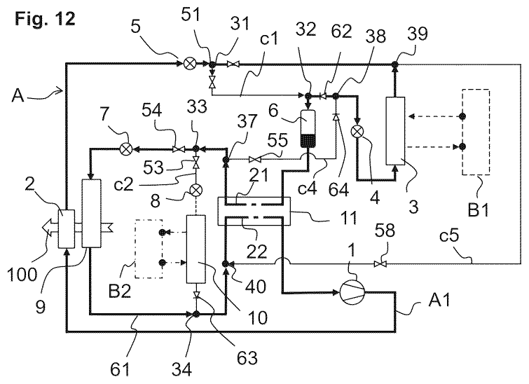

FIG. 12 is a schematic depiction of the thermal management device in FIG. 10 according to an eighth mode of operation.

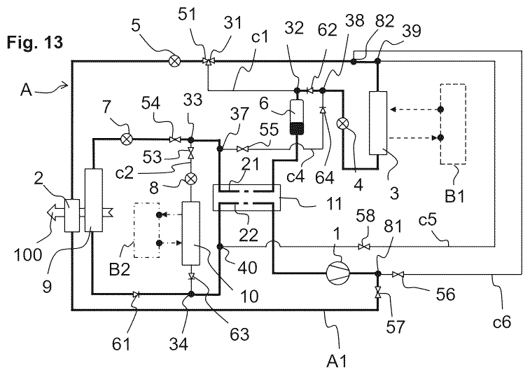

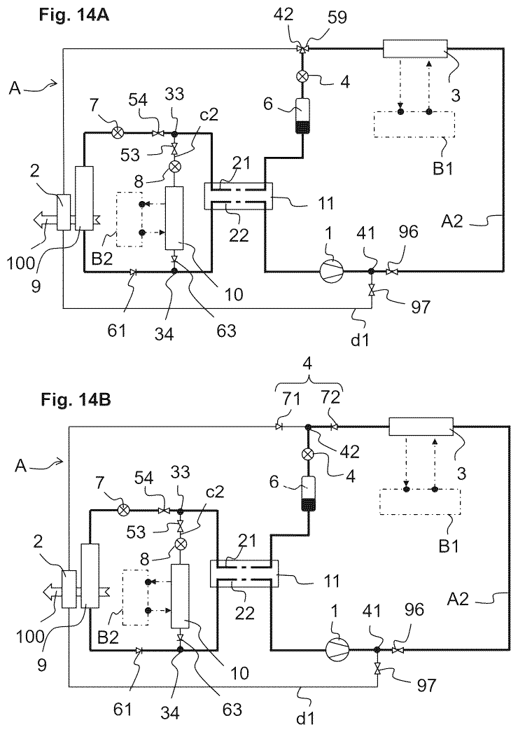

FIG. 13 is a schematic depiction of a thermal management device according to a fifth embodiment.

FIG. 14A and FIG. 14B show two schematic depictions of a thermal management device according to two variants of a sixth embodiment.

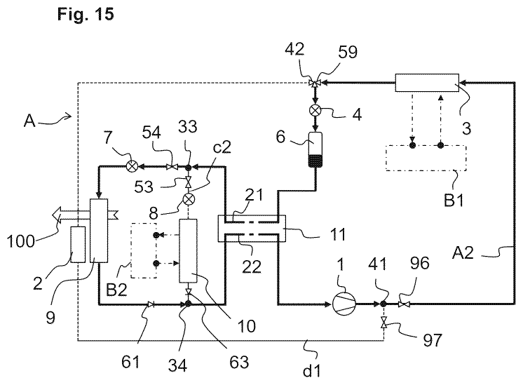

FIG. 15 is a schematic depiction of the thermal management device in FIGS. 14A, 14B according to a ninth mode of operation.

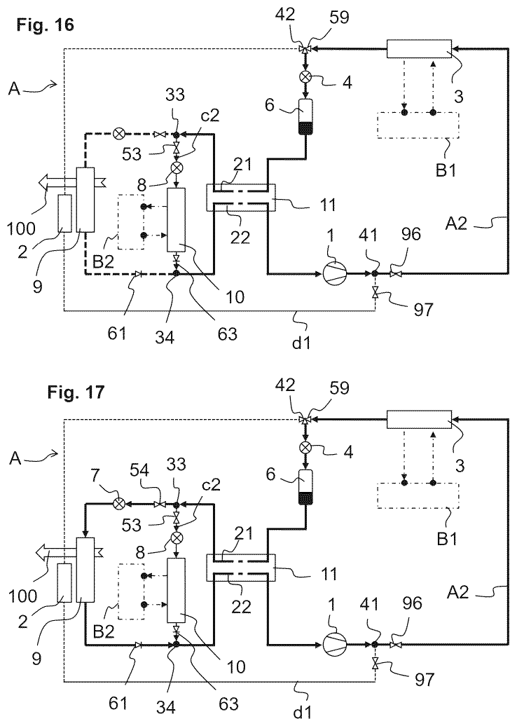

FIG. 16 is a schematic depiction of the thermal management device in FIGS. 14A, 14B according to a tenth mode of operation.

FIG. 17 is a schematic depiction of the thermal management device in FIGS. 14A, 14B according to an eleventh mode of operation.

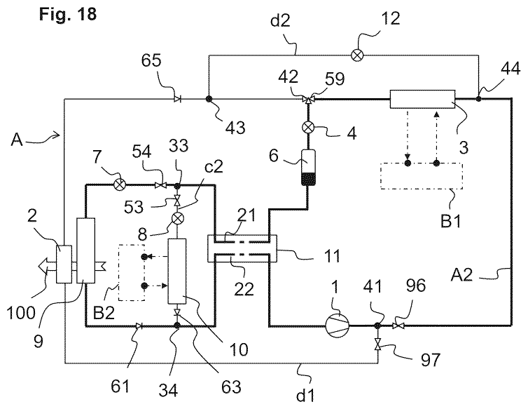

FIG. 18 is a schematic depiction of a thermal management device according to a seventh embodiment.

In the various figures, identical elements bear the same reference numbers.

The following embodiments are examples. Although the description refers to one or more embodiments, this does not necessarily mean that each reference sign refers to the same embodiment, or that the features apply only to one embodiment. Individual features of different embodiments may also be combined and/or interchanged to provide other embodiments.

In the present description, some elements or parameters may be indexed, such as first element or second element, and also first parameter and second parameter or else first criterion and second criterion, etc. In this case, the indexing is used simply to differentiate between and denote elements or parameters or criteria that are similar but not identical. This indexing does not imply priority being given to one element, parameter or criterion over another and such designations may be interchanged easily without departing from the scope of the present description. Neither does this indexing imply any chronological order for example in assessing any given criterion.

In the present description, “positioned upstream” is understood to mean that one element is positioned before another with respect to the direction of circulation of a fluid. By contrast, “positioned downstream” is intended to mean that one element is positioned after another with respect to the direction of circulation of the fluid.

### FIRST EMBODIMENT

FIG. 1 shows a thermal management device 1 for an electric or hybrid motor vehicle according to a first embodiment. This thermal management device 1 comprises a refrigerant circuit A, in which a refrigerant is intended to circulate.

This refrigerant circuit comprises a first main loop A1 comprising, in the direction of circulation of the refrigerant, a compressor 1, a condenser 2, 3 for absorbing heat energy from the refrigerant, a pre-expansion device 4, 5 disposed directly upstream of a storage cylinder 6, a main expansion device 7, 8 and an evaporator 9, 10 for transmitting heat energy to the refrigerant.

The terms “condenser” and “evaporator” are to be understood as meaning heat exchangers that are defined by their function and positioning in the first main loop A1 depending on the direction of circulation of the refrigerant. Thus, a condenser will be positioned, in the direction of circulation of the refrigerant, in a “high-pressure” portion of the refrigerant circuit A, in order to absorb heat energy from the refrigerant and transmit it to an auxiliary fluid, for example an air flow that passes through it or another heat transfer fluid. The refrigerant is generally in the gaseous phase at high pressure at the condenser inlet and in the liquid phase, or in the form of a liquid-gas mixture, still at high pressure, at the condenser outlet. An evaporator will be positioned, in the direction of circulation of the refrigerant, in a “low-pressure” portion of the refrigerant circuit A, in order to absorb heat energy from an auxiliary fluid, for example an air flow passing through it or from another heat transfer fluid, and transmit that heat energy to the refrigerant. The refrigerant is generally in the liquid phase or in the form of a liquid-gas mixture at low pressure in the gaseous phase at the evaporator inlet and in the gaseous phase, still at low pressure, at the evaporator outlet.

The storage cylinder 6 is installed between the condenser 2, 3 and the main expansion device 7, 8 to temporarily store the refrigerant conveyed from the condenser 2, 3 to the evaporator 9, 10, so that enough refrigerant is supplied to the evaporator 9, 10. The storage cylinder 6 can notably make it possible to eliminate the moisture and foreign substances present in the refrigerant and to supply the refrigerant in the fully liquid state to the expansion valve. The presence of such a storage cylinder therefore makes it possible to improve the efficiency of heat absorption at the evaporator 9, 10.

The presence of a pre-expansion device 4, 5 directly upstream of the storage cylinder 6 makes it possible to increase the sub-cooling of the refrigerant before it enters the evaporator 9, 10 and thus to obtain a greater difference in enthalpy between the inlet of the condenser 2, 3 and the outlet of the storage cylinder 6. This allows the refrigerant to recover more heat energy as it passes into the evaporator 9, 10. As will be seen later on in the description, the evaporator 10 can notably be disposed where the batteries of the vehicle are located.

### General Mode of Operation

FIG. 2 shows a general mode of operation of the thermal management device 1 of the invention shown in FIG. 1.

The refrigerant is firstly compressed at the compressor 1 and is thus in a “high-pressure and high-temperature” gaseous state. Then, the refrigerant passes into the condenser 2, 3 where it is condensed and experiences a loss of heat energy, and thus of temperature, to a first auxiliary flow (described in detail later on). At the outlet of the condenser 2, 3, the refrigerant is in the form of a gas/liquid mixture at high pressure. The refrigerant then passes through the pre-expansion device 4, 5 where it will experience a first pressure drop, which will make the refrigerant transition to an “intermediate” pressure. This first pressure drop makes it possible to cause some of the liquid portion of the refrigerant within the storage cylinder 6 to change to the gaseous phase. This change of phase involves drawing off some of the heat energy from the refrigerant and thus a drop in the enthalpy of the liquid phase. The pressure drop is less significant here than it is at the main expansion device 7, 8. The refrigerant then passes into the storage cylinder 6 where it will be purified and a separation of phase effected such that the refrigerant at the outlet of the storage cylinder 6 is in the liquid phase. At the outlet of the storage cylinder 6, the sub-cooling of the refrigerant is thus increased in relation to that at the outlet of the condenser 2, 3. The refrigerant then flows through a main expansion device 7, 8, where it experiences a second pressure drop and is made to transition from the “intermediate” pressure to a “low” pressure. The refrigerant then passes into the evaporator 9, 10 where it absorbs heat energy from a second auxiliary flow (described in detail later on), thereby increasing its enthalpy and causing it to transition into a gaseous state. The refrigerant lastly returns to the compressor 1.

### SECOND EMBODIMENT

FIG. 3 shows a second embodiment of the thermal management device of the invention in which the first main loop A1 is depicted in thick line.

In this second embodiment, as well as in the third and fourth embodiments illustrated in FIGS. 9 and 10, the condenser 2, 3 can notably be formed by two separate heat exchangers disposed in series on the first main loop A1. These heat exchangers can thus be a first condenser 2 and an additional heat exchanger 3 configured to act as a second condenser.

The first condenser 2 is intended to be flowed through by an auxiliary fluid and to transmit heat energy from the refrigerant to this auxiliary fluid.

In the embodiments and the modes of operation illustrated in FIGS. 3 to 18, the auxiliary fluid intended to flow through the first condenser 2 is an internal air flow 100. The first condenser 2 can then be for example an “internal” condenser disposed within a heating, ventilation and air conditioning (also referred to as HVAC) device. The internal air flow 100 is sent to the vehicle interior.

The auxiliary fluid with which the first condenser 2 can exchange heat energy can also be a heat transfer fluid circulating within an auxiliary thermal management circuit (not shown). The first condenser can thus be for example a two-fluid heat exchanger. It is thus entirely possible to imagine replacing, in the embodiments and modes of operation described below, the internal air flow 100 with a heat transfer fluid circulating within an auxiliary thermal management circuit.

Depending on the modes of operation, the first condenser 2 may be skipped, i.e. this auxiliary fluid does not flow through it, such that the refrigerant flowing through it does not experience an exchange of heat, or only experiences a very small exchange of heat, with this auxiliary fluid. If this auxiliary fluid is an internal air flow 100, when the latter arrives at the first condenser 2 it can be cut off, for example by a shut-off flap, or the internal air flow 100 can bypass the first condenser 2. If this auxiliary fluid is a heat transfer fluid in an auxiliary thermal management circuit, the circulation of the heat transfer fluid within the first condenser 2 can be stopped by an interruption of the auxiliary thermal management circuit or by a bypass around the first condenser 2.

Similarly, the additional heat exchanger 3 is intended to have both the refrigerant and an auxiliary fluid flowing through it. Depending on the modes of operation, the additional heat exchanger 3 may notably be configured to transfer heat energy from the auxiliary fluid to the refrigerant, thus heating the refrigerant, and in that case this heat exchanger acts as an evaporator. The additional heat exchanger 3 may also be configured to transfer heat energy from the refrigerant to the auxiliary fluid, thus cooling the refrigerant, and in that case this heat exchanger acts as a second condenser. This auxiliary fluid can notably be of the same type as or distinct from the auxiliary fluid flowing through the first condenser 2.

In the embodiments and the modes of operation illustrated in FIGS. 3 to 18, the auxiliary fluid intended to flow through the additional heat exchanger 3 is a first heat transfer fluid circulating within a first heat transfer circuit B1. The additional heat exchanger 3 can thus be a two-fluid heat exchanger disposed jointly on the refrigerant circuit A and on a first heat transfer fluid circuit B1 in which a first heat transfer fluid circulates. This first heat transfer fluid can be water or glycol water. The first heat transfer fluid circuit B1 may notably comprise one or more circuits which are parallel or meet at the additional heat exchanger 3 and are disposed where the front face of the vehicle is and/or where the batteries of the vehicle are and/or where an electric motor is and/or where the power electronics are. The first heat transfer fluid circuit B1 may notably also comprise at least one radiator disposed in the front face of the motor vehicle in order to discharge heat energy to the outside air.

The auxiliary fluid with which the additional heat exchanger can exchange heat energy can also be an air flow that passes through the latter. This variant is not depicted in FIGS. 3 to 18. It is thus entirely possible to imagine replacing, in the embodiments and modes of operation described below, the first heat transfer fluid circulating within the first heat transfer fluid circuit B1 with an air flow.

In order that a pre-expansion device 4, 5 is always disposed directly upstream of the storage cylinder 6 irrespective of the mode of operation, the thermal management device, and more particularly its main loop A1, may comprise a first pre-expansion device 4 disposed between the additional heat exchanger 3 and the storage cylinder 6 and a second expansion device 5 disposed between the first condenser 2 and the storage cylinder 6, as described in detail later on.

The pre-expansion device 4, 5 may be an expansion device with a variable diameter opening allowing the refrigerant to pass without a drop in pressure when open to its maximum diameter. As a result, notably, when the internal condenser 2 is not exchanging heat energy, or is exchanging very little heat energy, with the auxiliary fluid, the second pre-expansion device 5 does not affect the state of the fluid before the latter arrives at the additional heat exchanger 3. An alternative which is not depicted may also be for this pre-expansion device 4, 5 to be able to be bypassed.

As depicted in this FIG. 3, the refrigerant circuit A may notably be an air conditioning circuit in which the evaporator 9, 10 comprises a first heat exchanger 9 intended to be passed through by the internal air flow 100. The first heat exchanger 9 may be arranged within the heating, ventilation and air conditioning device 110, for example upstream of the first condenser 2 in the direction of flow of the internal air flow 100. In this case, the second auxiliary fluid corresponds to the internal air flow 100. A first main expansion device 7 is disposed upstream of the first heat exchanger 9.

The refrigerant circuit A may thus comprise a first main loop A1 comprising, in the direction of circulation of the refrigerant, the compressor 1, the first condenser 2, the additional heat exchanger 3, the first pre-expansion device 4, the storage cylinder 6, the first main expansion device 7, and the first heat exchanger 9.

Notably, the first main loop A1 may comprise an internal heat exchanger 11 disposed jointly on a first portion 21 and on a second portion 22 of the first main loop A1 in order to obtain an exchange of heat energy between these two portions. The first portion 21 is disposed between the storage cylinder 6 and the main expansion device 7, 8, and the second portion 22 is disposed between the evaporator 9, 10 and the compressor 1. This exchange of heat energy makes it possible to improve the performance coefficient of the refrigerant circuit A.

In order to be a reversible air conditioning circuit, the refrigerant circuit A may also comprise a first bypass pipe c1, depicted in fine line, joining a first connection point 31, disposed on the first main loop A1 downstream of the first condenser 2, to a second connection point 32, disposed on the first main loop A1 between the first pre-expansion device 4 and the storage cylinder 6. This first bypass pipe c1 allows the refrigerant A1 to bypass the additional heat exchanger 3 and makes it possible to connect the first condenser 2 and the storage cylinder 6 to one another. The second pre-expansion device 5 may be disposed on the first main loop A1 upstream of the first connection point 31, as depicted, or within the first bypass pipe c1. Thus, depending on the mode of operation, whether the refrigerant arrives at the storage cylinder 6 from the first condenser 2 or from the additional heat exchanger 3, it still flows through a pre-expansion device 4, 5 disposed directly upstream of the storage cylinder 6.

What is meant by reversible is that the refrigerant circuit A1 is capable of being able to cool or to heat the internal air flow 100, as required. The internal air flow 100 is notably cooled via the first heat exchanger 9 in a cooling mode of the thermal management device of the invention.

As shown in FIG. 3, the refrigerant circuit A1 may comprise a first device for controlling the circulation of the refrigerant from the first main loop A1 toward the first bypass pipe c1 at the first connection point 31. As depicted, this first control device may notably be a three-way valve 51 disposed at the first connection point 31. As an alternative, the first control device may comprise two shut-off valves each disposed downstream of the first connection point 31, one on the first main loop A1 and one on the first bypass pipe c1.

As also depicted in FIG. 3, the refrigerant circuit A1 may comprise a second device for controlling the circulation of the refrigerant from the first bypass pipe c1 toward the first main loop A1 at the second connection point 32. As depicted, the second control device may be a non-return valve 62 disposed on the first main loop A1 downstream of the first pre-expansion device 4, and more specifically between the second connection point 32 and the first pre-expansion device 4. This non-return valve 62 makes it possible to avoid the refrigerant that passes through the first bypass pipe c1 being directed to the first pre-expansion device 4. As an alternative, the second control device may be a shut-off valve.

In order that the refrigerant circuit A is reversible and enables several modes of operation, the evaporator 9, 10 may comprise a second heat exchanger 10. This second heat exchanger 10 may notably enable the thermal management and more particularly the cooling of the batteries of the electric or hybrid motor vehicle. Like the additional heat exchanger 3, the second heat exchanger may also be disposed jointly on the refrigerant circuit A and on a second heat transfer fluid circuit B2 within which a second heat transfer fluid is intended to circulate in order to allow an exchange of heat between these fluids. The second heat transfer fluid circuit B2 may notably comprise one or more circuits which are parallel or meet at the additional heat exchanger 3 and are disposed where the front face of the vehicle is and/or where the electric motor is and/or where the power electronics are.

As depicted in FIG. 3, the second heat exchanger 10 may be disposed on a second bypass pipe c2, depicted in fine line, of the refrigerant circuit A. The second bypass pipe c2 joins a third connection point 33, disposed on the first main loop A1 between the storage cylinder 6 and the first main expansion device 7, to a fourth connection point 34, disposed on the first main loop A1 downstream of the first heat exchanger 9. The second bypass pipe c2 comprises, in the direction of circulation of the refrigerant, a second main expansion device 8 disposed upstream of the second heat exchanger 10.

Notably, and as depicted in FIG. 3, the third connection point 33 is disposed between the internal heat exchanger 11 and the first main expansion device 7, and the fourth connection point 34 is disposed between the first non-return valve 61 and the first heat exchanger 9.

As shown in FIG. 3, the refrigerant circuit may comprise a third device for controlling the circulation of the refrigerant from the first main loop A1 toward the second bypass pipe c2. This third control device may notably be a three-way valve disposed at the third connection point 33. As an alternative, and as depicted, the third control device may comprise two shut-off valves 53, 54 each disposed downstream of the third connection point 33, one on the first main loop A1 and one on the second bypass pipe c2. As an alternative, the third control device may correspond to the main expansion devices 7, 8 of which the opening can be adjusted to allow the refrigerant to flow through them or prevent the refrigerant from flowing through them.

Also notably, the first main loop A1 may comprise a first non-return valve 61 disposed downstream of the first heat exchanger 9 and the second bypass pipe c2 may comprise a second non-return valve 63 disposed downstream of the second heat exchanger 10. More specifically, the first non-return valve 61 is disposed upstream of the fourth branch point 34 and makes it possible to avoid the refrigerant that is leaving the second heat exchanger 10 going back into the first exchanger 9. Furthermore, the second non-return valve 63 may be disposed between the second heat exchanger 10 and the fourth connection point 34. This second non-return valve 63 makes it possible to avoid refrigerant that is leaving the first heat exchanger 9 from getting to the second heat exchanger 10.

### First Mode of Operation

In the various depictions of the modes of operation of the thermal management device of the invention, the portions of the refrigerant circuit A1 in which the refrigerant does not circulate are depicted in dashed lines.

FIG. 4 illustrates a mode of operation in which the refrigerant circuit A is in a mode of cooling only the internal air flow 100 via the first heat exchanger 9.

In this mode of operation, the first control device, in this case the three-way valve 51, is configured to close off access to the first bypass pipe c1 such that the refrigerant circulates directly from the first condenser 2 toward the two-fluid heat exchanger 3. The third control device, for its part, is configured to close off access to the second bypass pipe c2 such that all the refrigerant coming from the storage cylinder 6 passes through the first heat exchanger 9.

In this mode of operation, the refrigerant leaves the compressor 1 at high pressure and passes in succession through the first condenser 2, optionally the second sub-cooling expansion device 5 if it is disposed on the first main loop A1, and the first connection point 31 where it is directed toward the additional heat exchanger 3 and arrives still at high pressure and without having exchanged heat energy by passing through the first condenser 2. To this end, the first condenser 2 is skipped, i.e. the internal air flow 100 does not flow through it, such that the refrigerant flowing through it does not experience an exchange of heat, or only experiences a very small exchange of heat, with the internal air flow 100. The second pre-expansion device 5 has a maximum opening if it is positioned on the first main loop A1.

As it flows through the additional heat exchanger 3, the refrigerant experiences a loss of heat energy to the first heat transfer fluid in the first heat transfer fluid circuit B1. The heat energy absorbed by the first heat transfer fluid in the first heat transfer fluid circuit B1 can be released into the outside air for example by means of a radiator disposed within the first heat transfer fluid circuit B1 positioned in the front face of the motor vehicle. The refrigerant then passes through the first pre-expansion device 4 where it experiences a first pressure drop so that it arrives at an “intermediate” pressure. The refrigerant then reaches the storage cylinder 6 via the second connection point 32. At the outlet of the storage cylinder 6, the refrigerant flows through the first portion 21 of the internal heat exchanger 11 where it will experience a third loss of heat energy to the refrigerant flowing in the second portion 22. The refrigerant continues to the third connection point 33 where it is directed toward the first main expansion device 7 and there experiences a second pressure drop greater than the first, so that it arrives at low pressure. The refrigerant then passes into the first heat exchanger 9, where it absorbs heat energy from the internal air flow 100. The internal air flow 100 is thus cooled. At the outlet of the first heat exchanger 9, the refrigerant goes to the fourth connection point 34. The refrigerant then continues toward the second portion 22 of the internal heat exchanger 11 where it absorbs heat energy from the first portion 21. The refrigerant then returns to the compressor 1.

### Second Mode of Operation

FIG. 4 also illustrates a second mode of operation in which the refrigerant circuit A is in a series demisting mode in which the internal air flow 100 is dehumidified.

Just as for the first mode of operation, the first control device is configured to close off access to the first bypass pipe c1, and the third control device is configured to close off access to the second bypass pipe c2.

In order to dehumidify the internal air flow 100 for demisting purposes, the internal air flow is first of all cooled to condense the moisture present therein and then heated before it reaches the vehicle interior and notably the windshield.

To this end, in this mode of operation, the internal air flow 100 flows through both the internal condenser 2 and the first heat exchanger 9. As a result, the refrigerant leaving the compressor 1 and flowing through the first condenser 2 experiences a first loss of heat energy to the internal air flow 100. The internal air flow 100 is then heated before it reaches the vehicle interior. The refrigerant continues toward the additional heat exchanger 3. In this case, as depicted, the second pre-expansion device 5 is disposed on the first main loop A1 and causes the refrigerant to experience a first pressure drop. In the additional heat exchanger 3, the refrigerant absorbs heat energy from the first heat transfer fluid in the first heat transfer fluid circuit B1 because it has already given up heat energy via the first condenser 2 and it has experienced a first pressure drop by flowing through the second pre-expansion device 5. The refrigerant then flows through the first pre-expansion device 4 where it possibly experiences a second pressure drop before it reaches the storage cylinder 6. The rest of this mode of operation is identical to the first mode of operation.

Thus, this second mode of operation uses the additional heat exchanger 3 as an evaporator.

### Third Mode of Operation

FIG. 5 illustrates a third mode of operation in which the refrigerant circuit A is in a mode of cooling only the batteries or the second heat transfer fluid via the second heat exchanger 10.

In this mode of operation, the first device is configured to close off access to the first bypass pipe c1, and the third control device is configured to open up access to the second bypass pipe c2 and close off access to the first heat exchanger 9.

In this mode of operation, the refrigerant arrives at the additional heat exchanger 3 without having experienced a drop in pressure or temperature. To this end, the first condenser 2 is skipped, i.e. the internal air flow 100 does not flow through it, such that the refrigerant flowing through it does not experience an exchange of heat, or only experiences a very small exchange of heat, with the internal air flow 100. The second pre-expansion device 5 has a maximum opening if it is positioned on the first main loop A1.

This mode of operation is identical to the first mode of operation except between the third connection point 33 and the fourth connection point 34. Here, the refrigerant is directed from the third connection point 33 toward the second main expansion device 8, where it will experience a second pressure drop greater than the first. It then passes into the second heat exchanger 10 where it will absorb heat energy given off by the batteries or the second heat transfer fluid. At the outlet of the second heat exchanger 10, the refrigerant passes through the non-return valve 63 and reaches the internal heat exchanger 11 via the fourth connection point 34.

### Fourth Mode of Operation

FIG. 6 illustrates a fourth mode of operation corresponding to the combination of the first and the third mode of operation, in which the refrigerant circuit A is in a mode of cooling both the internal air flow 100 via the first heat exchanger 9 and the batteries or the second heat transfer fluid via the second heat exchanger 10.

As a result, the refrigerant circulates in parallel:
in the first heat exchanger 9 to absorb heat energy from the internal air flow 100, and
in the second bypass pipe c2 to cool the batteries.

To this end, the second control device is configured to allow the refrigerant to pass into the first heat exchanger 9 and the second heat exchanger 10.

As a result, this mode of operation is identical to the first and the third mode of operation for the portions of the refrigerant circuit A in which the refrigerant is circulating, respectively.

### Fifth Mode of Operation

FIG. 7 illustrates a fifth, reversed mode of operation, in which the refrigerant circuit A is in a mode of heating the internal air flow 100 via the first condenser 2 and of recovering heat from the batteries or the second heat transfer fluid via the second heat exchanger 10.

In this mode of operation, the first control device is configured to close off access to the additional heat exchanger 3 and open up access to the first bypass pipe c1, and the third control device is configured to open up access to the second bypass pipe c2 and close off access to the first heat exchanger 9.

In this mode of operation, the refrigerant leaving the compressor 1 flows through the first condenser 2 and there experiences a loss of heat energy to the internal air flow 100. The internal air flow 100 is then heated before it reaches the vehicle interior. The refrigerant continues toward the second pre-expansion device 5 in which it experiences a first pressure drop. At the connection point 31, the refrigerant is directed toward the first bypass pipe c1, and then reaches the storage cylinder 6 via the second connection point 32. At the outlet of the storage cylinder 6, the refrigerant in the sub-cooled liquid phase flows through the internal heat exchanger 11 in the first portion 21 where it will experience a second loss of heat energy to the refrigerant flowing in the second portion 22. The refrigerant continues toward the third connection point 33 where it is directed toward the second main expansion device 8, and there it will experience a second pressure drop greater than the first. It then passes into the second heat exchanger 10 where it will absorb heat energy from the batteries or the second heat transfer fluid and transition to the gaseous phase. At the outlet of the second heat exchanger 10, the refrigerant goes to the internal heat exchanger 11 via the fourth connection point 34. In the second portion 22 of the internal heat exchanger 11, the refrigerant absorbs heat energy from the first portion 21. The refrigerant then returns to the compressor 1.

### Sixth Mode of Operation

FIG. 8 illustrates a sixth mode of operation in which the refrigerant circuit A is in a parallel demisting mode in which the internal air flow 100 is dehumidified.

In this embodiment, the first control device is configured to close off access to the additional heat exchanger 3 and open up access to the first bypass pipe c1, and the second control device is configured to allow the refrigerant to flow in the first and the second heat exchanger.

This mode of operation is identical to the fifth mode of operation except that the refrigerant circulates in parallel:
in the first heat exchanger 9 to absorb heat energy from the internal air flow 100, and
in the second bypass pipe c2 to recover heat from the batteries or from the second heat transfer fluid circuit B2 via the second heat exchanger 10.

Like in the second mode of operation, passing into the first heat exchanger 9 makes it possible to absorb heat energy from the internal air flow 100 in order to condense the moisture upstream of being heated by the first condenser 2.

### THIRD EMBODIMENT

FIG. 9 shows a third embodiment of the thermal management device of the invention.

This third embodiment includes a first main loop A1, in thick line, which is identical to that of the second embodiment in FIGS. 3 to 8.

The first bypass pipe c1 of the second embodiment is here replaced with a third bypass pipe c3 joining a fifth connection point 35, disposed on the first main loop A1 downstream of the first condenser 2, to a sixth connection point 36, disposed on the first main loop A1 upstream of the first pre-expansion device 4, and more specifically between the additional heat exchanger 3 and the first pre-expansion device 4. Thus, in this embodiment, it is not necessary to provide the second pre-expansion device 5 when the refrigerant does not pass through the additional heat exchanger 3.

A secondary expansion device 12 may be disposed on the main loop A1 upstream of the additional heat exchanger 3, and more specifically between the fifth connection point 35 and the additional heat exchanger 3. This secondary expansion device 12 may be an expansion device with a variable diameter opening allowing the refrigerant to pass without a drop in pressure when open to its maximum diameter. An alternative may also be for this secondary expansion device 12 to be able to be bypassed.

The main loop A1 may comprise a non-return valve 65 which is disposed between the first condenser 2 and the ninth connection point 39 and makes it possible to avoid refrigerant flowing back toward the first condenser 2.

The main loop A1 may comprise a fourth device for controlling the circulation of the refrigerant from the first main loop A1 toward the first bypass pipe c3 at the fifth connection point 35. This fourth control device may notably be a shut-off valve (not shown) disposed on the main branch A1 downstream of the fifth connection point 35. As an alternative, it is the secondary expansion device 12 that comprises a flow stoppage function, like the main expansion devices 7, 8.

The first main loop A1 may in this case comprise a fifth device for controlling the circulation of the refrigerant from the first main loop A1 toward the first bypass pipe c3 at the sixth connection point 36. This fifth control device may notably be a three-way valve 60 disposed, as depicted, at the sixth connection point 36. As an alternative, the fifth control device may comprise two shut-off valves each disposed upstream of the sixth connection point 36, one on the first main loop A1 and one on the third bypass pipe c3.

The six embodiments described in relation to the second embodiment apply similarly to the third embodiment, except that:
for the four first modes of operation, the fourth control device is configured to open up access to the additional heat exchanger 3 and the fifth control device is configured to close off access to the third bypass pipe c3 and open up access to the first pre-expansion device 4 and the additional heat exchanger 3,
for the first, second and third modes of operation, the secondary expansion device 12 has flow passing through it, i.e. it has a maximum opening such that the refrigerant can flow through it with a minimum pressure drop, like the second pre-expansion device 5 in some modes of operation of the second embodiment,
for the fifth and sixth modes of operation, the refrigerant passes into the third bypass pipe c3. To this end, the fifth control device is configured to open up access to the third bypass pipe c3 and close off access to the additional heat exchanger 3 such that the refrigerant circulates directly from the first condenser 2 to the first sub-cooling expansion device 4.

### FOURTH EMBODIMENT

FIG. 10 shows a fourth embodiment of the thermal management device of the invention.

This fourth embodiment can be used for the various embodiments described in relation to the second embodiment and enables new modes of operation in which the additional heat exchanger 3 is like an evaporator. To this end, this embodiment reprises the portions of the refrigerant circuit A of the second embodiment and further comprises a fourth and a fifth bypass pipe c4, c5, in fine line.

The fourth bypass pipe c4 joins a seventh connection point 37, disposed on the first main loop A1 downstream of the storage cylinder 6, to an eighth connection point 38, disposed on the first main loop A1 between the first pre-expansion device 4 and the storage cylinder 6. Notably, the third bypass point 33 is disposed downstream of the internal heat exchanger 11, and upstream of the first main expansion device 7 and second main expansion device 8. As an alternative, the seventh connection point 37 is combined with the third connection point 33. Notably, the eighth connection point 38 is upstream of the connection point 32 and more particularly upstream of the non-return valve 62.

The fourth bypass pipe c4 may comprise a non-return valve 64 for avoiding the refrigerant that comes from the first pre-expansion device 4 bypassing the storage cylinder 6 by passing through the fourth bypass pipe c4.

The fifth bypass pipe c5 joins a ninth connection point 39, disposed on the first main loop A1 downstream of the additional heat exchanger 3, to a tenth connection point 40, disposed on the first main loop A1 downstream of the evaporator 9, 10. Notably, the tenth connection point 40 is disposed between the evaporator 9, 10 and the internal heat exchanger 11. Again notably, the tenth connection point 40 is disposed between the fourth connection point 34 and the internal heat exchanger 11.

The third control device may comprise a shut-off valve 55 disposed on the fourth bypass pipe c4 downstream of the seventh connection point 37 in order to allow or not allow the refrigerant to circulate in the fourth bypass pipe c4. As an alternative, the first pre-expansion device 4 may be configured to be able to stop a flow from going back to the additional heat exchanger 3.

The fifth bypass pipe c5 may comprise a shut-off valve 58 in order to prevent the refrigerant that is leaving the evaporator 9, 10 from going back to the two-fluid heat exchanger 3 in the six first embodiments.

### Seventh Mode of Operation

FIG. 11 illustrates a seventh mode of operation (for the fourth embodiment in FIG. 10), in which the refrigerant circuit A is in a mode of heating the internal air flow 100 via the first condenser 2 and of recovering heat from the first heat transfer fluid circuit B1 via the additional heat exchanger 3.

As a result, in this mode of operation the refrigerant flows through the additional heat exchanger 3 not upstream, but downstream of the storage cylinder 6. The first pre-expansion device 4 therefore in this case is designed not to make the refrigerant experience a pressure drop upstream of the storage cylinder 6 but to cause the refrigerant to expand in order that it transitions to a low pressure before it flows through the additional heat exchanger 3 and that it does not absorb the heat energy from the first heat transfer fluid in the first heat transfer fluid circuit B1.

To that end,
the first control device is configured to redirect the refrigerant coming from the first condenser 2 toward the first bypass pipe c1 and close off access to the additional heat exchanger 3 for the refrigerant coming from the first condenser 2, and
the third control device is configured on the one hand to allow the refrigerant coming from the storage cylinder 6 to pass into the fourth bypass pipe c4 and on the other hand to prevent the refrigerant from circulating toward the first heat exchanger 9 and through the second bypass pipe c2.

In this mode of operation, the refrigerant leaving the compressor 1 flows through the first condenser 2 and there experiences a first loss of heat energy to the internal air flow 100. The internal air flow 100 is thus heated before it reaches the vehicle interior. The refrigerant continues toward the second pre-expansion device 5 in which it experiences a first pressure drop. At the connection point 31, the refrigerant is directed toward the first bypass pipe c1, and then reaches the storage cylinder 6 via the second connection point 32. At the outlet of the storage cylinder 6, the refrigerant is entirely in liquid form and flows through the internal heat exchanger 11 in the first portion 21 where it will experience a second loss of heat energy to the refrigerant flowing in the second portion 22. The refrigerant continues toward the seventh connection point 37 where it is directed toward the fourth bypass pipe c4. The refrigerant is directed toward the first pre-expansion device 4. The refrigerant is prevented from returning to the storage cylinder 6 at the non-return valve 62 by the greater pressure exerted there by the refrigerant arriving from the first bypass pipe c1. At the first pre-expansion device 4, the refrigerant experiences a second pressure drop. The refrigerant then passes into the additional heat exchanger 3 where it will absorb heat energy from the first heat transfer fluid in the first heat transfer fluid circuit B1. The refrigerant leaving the additional heat exchanger 3 arrives at the ninth connection point 39, where it is directed toward the fifth bypass pipe c5 insofar as the first control device closes off access to the exchanger 3. The refrigerant then goes to the first main loop A1 at the tenth connection point 40, and then is directed toward the internal heat exchanger 11 by the action of the non-return valves 61, 63 which prevents it from going back to the first heat exchanger 9 and the second heat exchanger 10. In the second portion 22, the refrigerant absorbs heat energy from the first portion 21. The refrigerant then returns to the compressor 1.

### Eighth Mode of Operation

FIG. 12 illustrates an eighth mode of operation (for the fourth embodiment in FIG. 10) in which the refrigerant circuit A is in a parallel demisting mode in which the internal air flow 100 is dehumidified. This mode of operation thus represents an alternative to the sixth mode of operation in FIG. 8.

In this case, instead of it being the second heat exchanger 10 which recovers heat energy in parallel with the first heat exchanger 9, it is the additional heat exchanger 3 which does this.

To this end, the refrigerant circulates in parallel:
in the first heat exchanger 9 to absorb heat energy from the internal air flow 100, and
in the fourth bypass column c4 and fifth bypass column c5 in order to recover heat from the first heat transfer fluid in the first heat transfer fluid circuit B1 via the additional heat exchanger 3.

As a result, this mode of operation is similar to the seventh mode of operation except that the refrigerant at the seventh connection point 37 is split into two parts, a first part being directed toward the fourth bypass pipe c4 and a second part being directed toward the third connection point 33 in the direction of the first main expansion device 7 and the first heat exchanger 9. The two parts of the refrigerant then meet at the tenth connection point 40 and then pass through the internal heat exchanger 11 and return to the compressor 1.

In this mode of operation:
the first control device is configured to redirect the refrigerant coming from the first condenser 2 toward the first bypass pipe c1 and close off access to the additional heat exchanger 3 for the refrigerant coming from the first condenser 2, and
the second control device is configured on the one hand to allow the refrigerant coming from the storage cylinder 6 to pass into the fourth bypass pipe c4 and toward the first heat exchanger 9 and on the other hand to prevent the refrigerant from circulating through the second bypass pipe c2.

### FIFTH EMBODIMENT

FIG. 13 illustrates the fifth embodiment.

This fifth embodiment corresponds to a variant of the fourth embodiment in FIG. 10 comprising a sixth bypass pipe which makes it possible to bypass the first condenser 2 for the cooling modes of operation (first, third and fourth modes of operation).

This fifth embodiment therefore comprises a sixth bypass pipe c6 joining an eleventh connection point 81, disposed on the first main loop A1 downstream of the compressor 1, to a twelfth connection point 82, disposed on the first main loop A1 upstream of the additional heat exchanger 3. More specifically, the eleventh connection point 81 is disposed between the compressor 1 and the first condenser 2, and the twelfth connection point 82 is disposed between the first connection point 31 and the two-fluid exchanger 3. Notably, the twelfth connection point is disposed upstream or downstream of the ninth connection point 39. In an alternative, the twelfth connection point is disposed on the third bypass pipe c5, notably upstream of the shut-off valve 58.

As shown in FIG. 13, the refrigerant circuit may comprise a sixth device for controlling the circulation of the refrigerant from the first main loop A1 toward the sixth bypass pipe c6 at the eleventh connection point 81. This sixth control device may notably be a three-way valve disposed at the eleventh connection point 81. As an alternative, and as depicted, the sixth control device may comprise two shut-off valves 56, 57 each disposed downstream of the eleventh connection point 81, one on the first main loop A1 and one on the sixth bypass pipe. The shut-off valves 56, 57 may have an electronically controlled variable opening.

As regards the cooling embodiments, the refrigerant leaving the compressor 1 arrives at the eleventh connection point 81, where it is directed toward the sixth bypass pipe c6. The refrigerant then reaches the additional heat exchanger 3 via the twelfth connection point 82. The rest of the respective realization of these modes of operation is identical to what is described in relation to the second embodiment.

In addition, this fifth way of carrying out the second mode of operation, and the fifth to eighth embodiments are identical to what is described above.

### SIXTH EMBODIMENT

A sixth and a seventh embodiment are depicted in FIGS. 14A to 18 and comprise a second main loop A2, in bold line, which directly connects the compressor 1 to the additional heat exchanger 3.

The second main loop A2 comprises, in the direction of circulation of the refrigerant, the compressor 1, the additional heat exchanger 3, the first pre-expansion device 4, the storage cylinder 6 and the evaporator 9, 10. Notably, the second main loop A2 may also comprise the internal heat exchanger 11.

FIGS. 14A, 14B depict two variants (A and B) of the sixth embodiment in which the second main loop A2 comprises, downstream of the storage cylinder 6, the first main expansion device 7 and the first heat exchanger 9. The two variants differ in terms of the elements used for the first pre-expansion device 4.

In a first variant, depicted in FIG. 14A, the pre-expansion device 4 is identical to that used in the five first embodiments.

In this case, and as depicted in this FIG. 14A, the refrigerant circuit A may comprise a first bypass branch d1 connecting a first junction point 41, disposed on the second main loop A2 downstream of the compressor 1, to a second junction point 42, disposed on the second main loop A2 between the additional heat exchanger 3 and the first pre-expansion device 4.

As shown in FIG. 14A, the refrigerant circuit may comprise a seventh device for controlling the circulation of the refrigerant from the second main loop A2 toward the first bypass branch d1 at the first junction point 41. This seventh control device may notably be a three-way valve disposed at the first junction point 41. As an alternative, and as depicted, the seventh control device may comprise two shut-off valves 96, 97 each disposed downstream of the first junction point 41, one on the second main loop A2 and one on the first bypass branch d1. The shut-off valves 96, 97 may have an electronically controlled variable opening.

As is also depicted, the refrigerant circuit may comprise an eighth device for controlling the circulation of the refrigerant from the second main loop A2 toward the first bypass branch d1 at the second junction point 42. In the first variant of this sixth embodiment, this eighth control device may notably be a three-way valve 59, as depicted in FIG. 14A, disposed at the second junction point 42. As an alternative, the eighth control device may comprise two shut-off valves, one disposed downstream of the second junction point 42 on the second main loop A2 and the other disposed upstream of the second junction point 42 on the first bypass branch d1.

According to the second variant of the sixth embodiment depicted in FIG. 14B, the pre-expansion device 4 is formed by two pre-programmed non-return valves 71, 72 disposed upstream of the second junction point 42 on the first bypass branch d1 and on the second main loop A2, respectively.

As a result, in this case the eighth control device may correspond to the two pre-programmed non-return expansion valves 71, 72.

The other elements described in relation to the first variant are identical in the second variant.

As depicted in FIGS. 14A and 14B, the refrigerant circuit A may comprise the second bypass pipe c2 comprising the second main expansion device 8 and the second heat exchanger 10.

The parallel demisting mode in which the internal air flow 100 is dehumidified (sixth mode of operation) and the mode of heating the internal air flow 100 via the first condenser 2 and of recovering heat from the second heat transfer fluid (fifth mode of operation) that were described in relation to the third embodiment apply similarly to the first variant of this sixth embodiment.

In brief, for the mode of heating the internal air flow 100 via the first condenser 2 and of recovering heat from the second heat transfer fluid, the refrigerant leaving the compressor 1 firstly arrives at the first junction point 41 where it is directed toward the internal exchanger 2 through which it passes and where it experiences a loss of heat energy to the internal air flow 100. The internal air flow 100 is thus heated before it reaches the vehicle interior. The refrigerant continues toward the second junction point 42 where it is directed toward the first pre-expansion device 4, and there experiences a first pressure drop. Then, the refrigerant reaches the storage cylinder 6. At the outlet of the storage cylinder 6, the refrigerant in the sub-cooled liquid phase flows through the internal heat exchanger 11 in the first portion 21 where it will experience a second loss of heat energy to the refrigerant flowing in the second portion 22. The refrigerant continues toward the third connection point 33 where it is directed toward the second main expansion device 8, and there it will experience a second pressure drop greater than the first. It then passes into the second heat exchanger 10 where it will absorb heat energy from the batteries or the second heat transfer fluid and transition to the gaseous phase. At the outlet of the second heat exchanger 10, the refrigerant goes to the internal heat exchanger 11 via the fourth connection point 34. In the second portion 22 of the internal heat exchanger 11, the refrigerant absorbs heat energy from the first portion 21. The refrigerant then returns to the compressor 1.

In brief, for the parallel demisting mode in which the internal air flow 100 is dehumidified, this mode is identical to the mode of heating the internal air flow 100 described above, except that the refrigerant circulates in parallel:
in the first heat exchanger 9 to absorb heat energy from the internal air flow 100, and
in the second bypass pipe c2 to recover heat from the batteries or from the second heat transfer fluid circuit B2 via the second heat exchanger 10.

As regards the second variant of the sixth embodiment, the various modes of operation described in relation to the first variant are identical except that the first expansion is performed by one of the shut-off valves 71, 72 upstream of the second junction point 42, depending on the mode of operation.

### Ninth Mode of Operation

FIG. 15 illustrates a mode of operation (for the sixth mode of operation in FIGS. 14A and 14B) in which the refrigerant circuit A is in a mode of cooling only the internal air flow 100 via the first heat exchanger 9.

In this mode of operation, the fifth and the eighth control device are configured to close off access to the first bypass branch d1.

In this embodiment, the refrigerant arrives firstly at the first junction point 41, where it is directed toward the additional heat exchanger 3. At the additional heat exchanger 3, it gives up heat energy to the first heat transfer fluid in the first heat transfer fluid circuit B1. It then goes to the first pre-expansion device 4 via the second junction point 42. At the first pre-expansion device 4, the refrigerant experiences a first pressure drop. The refrigerant then reaches the storage cylinder 6. At the outlet of the storage cylinder 6, the refrigerant flows through the first portion 21 of the internal heat exchanger 11 where it will experience a third loss of heat energy to the refrigerant flowing in the second portion 22. The refrigerant continues to the third connection point 33 where it is directed toward the first main expansion device 7 and there experiences a second pressure drop greater than the first, so that it arrives at low pressure. The refrigerant then passes into the first heat exchanger 9, where it absorbs heat energy from the internal air flow 100. The internal air flow 100 is thus cooled. At the outlet of the first heat exchanger 9, the refrigerant goes to the fourth connection point 34. The refrigerant then continues toward the second portion 22 of the internal heat exchanger 11 where it absorbs heat energy from the first portion 21. The refrigerant then returns to the compressor 1.

### Tenth Mode of Operation

FIG. 16 illustrates a tenth mode of operation (for the sixth mode of operation in FIGS. 14A and 14B) in which the refrigerant circuit A is in a mode of cooling only the batteries via the second heat exchanger 9.

This mode of operation is identical to the ninth mode of operation except between the third connection point 33 and the fourth connection point 34. Here, the refrigerant is directed from the third connection point 33 toward the second main expansion device 8, where it will experience a second pressure drop greater than the first. It then passes into the second heat exchanger 10 where it will absorb heat energy given off by the batteries. At the outlet of the second heat exchanger 10, the refrigerant goes to the internal heat exchanger 11 via the fourth connection point 34 before returning to the compressor 1.

### Eleventh Mode of Operation

FIG. 17 illustrates an eleventh mode of operation (for the sixth mode of operation in FIGS. 14A and 14B) corresponding to the combination of the ninth and the tenth mode of operation, in which the refrigerant circuit A is in a mode of cooling both the internal air flow 100 and the batteries.

As a result, the refrigerant circulates in parallel:
in the first heat exchanger 9 to absorb heat energy from the internal air flow 100, and
in the second bypass pipe c2 to cool the batteries.

To this end, the second control device is configured to allow the refrigerant to pass into the first and the second heat exchanger 9, 10.

### SEVENTH EMBODIMENT

FIG. 18 illustrates a seventh embodiment of the invention.

This seventh embodiment is a variant of the sixth embodiment and therefore reprises the elements to which is added a second bypass branch d2 connecting a third junction point 43, disposed on the first bypass branch d1 downstream of the first condenser 2, to a fourth junction point 44, disposed on the second main loop A2 upstream of the additional heat exchanger 3.

In this embodiment, the first bypass branch d1 may comprise the non-return valve 65, which in this case is disposed between the first condenser 2 and the third connection point 33. In addition, the second bypass branch d2 may comprise the secondary expansion device 12.

All of the modes of operation described in relation to the sixth embodiment apply to this seventh embodiment. In addition, this seventh embodiment enables a mode of operation in which the refrigerant circuit A is in a series demisting mode in which the internal air flow 100 is dehumidified.

In this case, the refrigerant leaving the compressor 1 arrives firstly at the first junction point 41 where it is directed toward the first condenser 2, through which it passes and experiences a loss of heat energy there to the internal air flow 100. The internal air flow 100 is thus heated before it reaches the vehicle interior. The refrigerant continues toward the second junction point 42 where it is directed toward the secondary expansion device 12, within which it experiences a first pressure drop. The refrigerant continues toward the additional heat exchanger 3.

Within the additional heat exchanger 3, the refrigerant absorbs heat energy from the first heat transfer fluid in the first heat transfer fluid circuit B1 because it has already given up heat energy via the first condenser 2 and it has experienced a first pressure drop by flowing through the secondary expansion device 12. The refrigerant then arrives at the second junction point 42 where it is directed toward the first pre-expansion device 4. The refrigerant then flows through the first pre-expansion device 4 where it possibly experiences a second pressure drop before it reaches the storage cylinder 6. The rest of this mode of operation is identical to the ninth mode of operation.

1. A thermal management device for an electric or hybrid motor vehicle, said thermal management device comprising a refrigerant circuit inside which a refrigerant circulate, the refrigerant circuit comprising, in a direction of circulation of the refrigerant:
a compressor;
a condenser for absorbing heat energy from the refrigerant;
a pre-expansion device disposed directly upstream of a storage cylinder;
a main expansion device; and
an evaporator for transmitting heat energy to the refrigerant.

2. The thermal management device as claimed in claim 1,
wherein the condenser comprises an additional heat exchanger through which both the refrigerant and an auxiliary fluid flow,
wherein the pre-expansion device comprising a first pre-expansion device, and
wherein the thermal management device comprises, in the direction of circulation of the refrigerant, a main loop comprising, in the direction of the refrigerant:
the compressor;
the additional heat exchanger;
the first pre-expansion device disposed directly upstream of the storage cylinder;
the main expansion device; and
the evaporator.

3. The thermal management device as claimed in claim 2,
wherein the main loop is a first main loop,
wherein the condenser further comprises a first condenser (2) which transmit heat energy to an auxiliary fluid and is disposed on the first main loop in the direction of circulation of the refrigerant between the compressor and the additional heat exchanger.

4. The thermal management device as claimed in claim 3,
wherein the pre-expansion device comprises a second pre-expansion device,
wherein the thermal management device comprises a first bypass pipe joining a first connection point, disposed on the first main loop downstream of the first condenser, to a second connection point, disposed on the first main loop between the first pre-expansion device and the storage cylinder, and
wherein the second pre-expansion device is disposed between the first condenser and the storage cylinder.

5. The thermal management device as claimed in claim 4, further comprising
a fourth bypass pipe joining a seventh connection point, disposed on the first main loop downstream of the storage cylinder, to an eighth connection point, disposed on the first main loop (A1) between the first pre-expansion device and the storage cylinder, and
a fifth bypass pipe joining a ninth connection point, disposed on the first main loop downstream of the additional heat exchanger, to a tenth connection point, disposed on the first main loop downstream of the evaporator.

6. The thermal management device as claimed in claim 3, further comprising a sixth bypass pipe joining an eleventh connection point, disposed on the first main loop downstream of the compressor, to a twelfth connection point, disposed on the first main loop upstream of the additional heat exchanger.

7. The thermal management device as claimed in claim 3, further comprising a third bypass pipe joining a fifth connection point, disposed on the first main loop downstream of the first condenser, to a sixth connection point, disposed on the first main loop between the additional heat exchanger and the first pre-expansion device.

8. The thermal management device as claimed in claim 2,
wherein the main loop is a second main loop,
wherein the condenser further comprises a first condenser for transmitting heat energy to an internal air flow, and
wherein the thermal management device comprises, in the direction of circulation of the refrigerant, a first bypass branch connecting a first junction point, disposed on the second main loop downstream of the compressor, to a second junction point, disposed on the second main loop upstream of the first pre-expansion device,
wherein said first bypass branch comprising the first condenser.

9. The thermal management device as claimed in claim 8, further comprising a second bypass branch connecting a third junction point, disposed on the second main loop downstream of the first condenser, to a fourth junction point, disposed on the second main loop upstream of the additional heat exchanger, wherein said second bypass branch comprising a secondary expansion device.
